(19) United States
(12) Patent Application Publication
(10) Pub. No.: US 2011/0080082 A1
(43) Pub. Date: Apr. 7, 2011

(54) SLIDING RAIL

(75) Inventor: RUEI-LIN JHU, Shulin City (TW)

(73) Assignee: SHIN ZU SHING CO., LTD., Shulin City (TW)

(21) Appl. No.: 12/571,600

(22) Filed: Oct. 1, 2009

(51) Int. Cl. F16C 29/02; A47B 97/00

(52) U.S. Cl. 312/334.1; 384/37

(57) ABSTRACT

A sliding rail has a stationary base, a slider and two plugs. The stationary base is elongated and has two ends, two opposite edges and two channels defined respectively in the edges, and each channel having a top, a bottom and two open ends respectively at the ends of the stationary base. The slider is mounted slidably on the stationary base and has two edges respectively mounted slidably in the channels in the stationary base. Each edge of the slider has two resilient arms mounted on and protruding obliquely from the edge. Each arm has two ends abutting respectively with the top and the bottom of a corresponding channel in the stationary base. The plugs are mounted respectively on the ends of the stationary base to close the open ends of the channels.

### BACKGROUND OF THE INVENTION

1. Field of the Invention

The present invention relates to a sliding rail, and more particularly to a sliding rail for an object having a slidable cover.

2. Description of Related Art

Objects having slidable covers, such as digital cameras or cell phones have sliding rails mounted between the slidably cover and a body of the object to allow the cover to be slid and opened relative to the body.

With reference to FIG. 8, a conventional sliding rail comprises a securing element (51), a sliding element (52) and two hoods (53). The securing element (51) is mounted securely on a body of an object and has two channels (511) defined respectively in two edges of the securing element (51). The sliding element (52) is mounted securely on a cover of the object and has two edges respectively mounted slidably in the channels (511) of the securing element (51). The hoods (53) are resilient and are mounted respectively around the edges of the sliding element (52). Each hood (53) has a recess (531) to hold a corresponding edge of the sliding element (52) inside.

Because the securing element (51) and the sliding element (52) are metal, gaps are easily formed between the channels (511) and the edges of the sliding element (52) due to manufacturing errors. This will cause unstable movement of the sliding element (52) relative to the securing element (51). Therefore, the resilient hoods (53) can fill the gaps to make the sliding element (52) move stably. However, to mount the hoods (53) around the edges of the sliding element (52) and to put the edges of the sliding element (52) with the hoods (53) into the channels (511) in the securing element (51) hinders assembly of the conventional sliding rail and increases manufacturing costs. Volume of the conventional sliding rail may be enlarged for arrangement of the resilient hoods (53), so to minimizing a volume of the conventional sliding rail is difficult.

To overcome the shortcomings, the present invention tends to provide a sliding rail to mitigate or obviate the aforementioned problems.

### SUMMARY OF THE INVENTION

The main objective of the invention is to provide a sliding rail for an object having a slidable cover to make the cover move stably relative to a body of the object. The sliding rail has a stationary base, a slider and two plugs. The stationary base is elongated and has two ends, two opposite edges and two channels defined respectively in the edges, and each channel has a top, a bottom and two open ends respectively at the ends of the stationary base. The slider is mounted slidably on the stationary base and has two edges respectively mounted slidably in the channels in the stationary base. Each edge of the slider has two resilient arms mounted on and protruding obliquely from the edge. Each arm has two ends abutting respectively with the top and the bottom of a corresponding channel in the stationary base. The plugs are mounted respectively on the ends of the stationary base to close the open ends of the channels.

Other objects, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a sliding rail in accordance with the present invention;

FIG. 2 is an enlarged exploded perspective view of the sliding rail in FIG. 1;

FIG. 3 is a side view of the sliding rail in FIG. 1;

FIG. 4 is a cross sectional top view of the sliding rail along line 4-4 in FIG. 3;

FIG. 5 is a cross sectional top view in partial section of the sliding rail along line 5-5 in FIG. 3;

FIG. 6 is a cross sectional end view of the sliding rail along line 6-6 in FIG. 3;

FIG. 7 is an exploded perspective view of an object with two sliding rails in FIG. 1; and

FIG. 8 is partial side view in cross section of a conventional sliding rail in accordance with the prior art.

### DETAILED DESCRIPTION OF PREFERRED EMBODIMENT

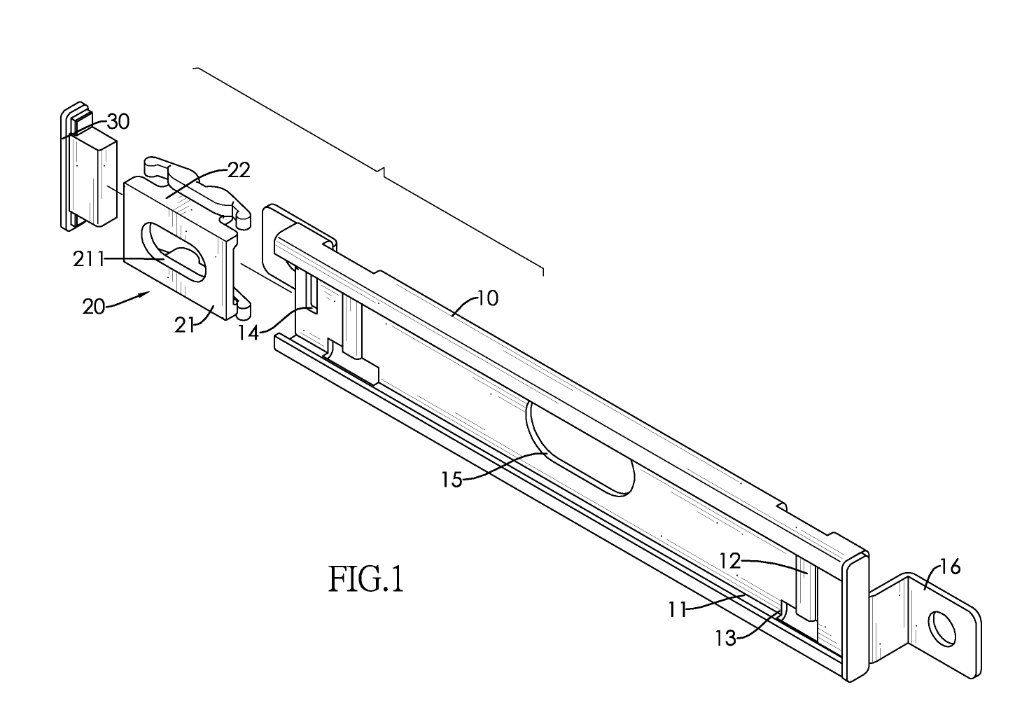

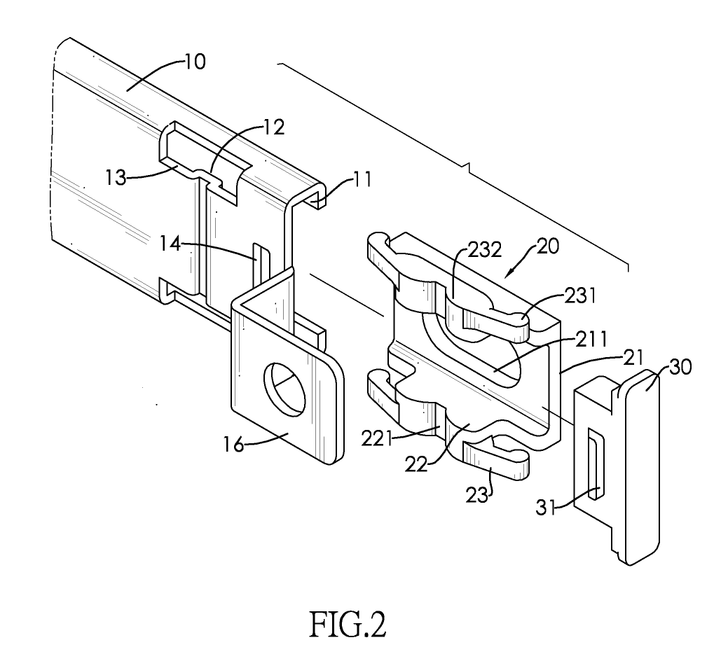

With reference to FIGS. 1, 2 and 7, a sliding rail in accordance with the present invention is mounted on an object, especially on an electronic object, such as a digital camera or a cell phone. The sliding rail comprises a stationary base (10), a slider (20) and two plugs (30).

The stationary base (10) is connected securely to a body (42) of the object, is elongated and has two ends, two opposite edges, two channels (11), two protrusions (12), four slots (13), two positioning holes (14), two mounting feet (16) and an elongated hole (15).

The channels (11) are defined respectively in the edges at a side of the stationary base (10). Each channel (11) has a top, a bottom and two open ends respectively at the ends of the stationary base (10). The protrusions (12) are formed respectively near the ends of the stationary base (10) at the side defining the channels (11). The slots (13) are defined through the stationary base (10) respectively at ends of the protrusions (12). The positioning holes (14) are defined respectively near the ends of the stationary base (10), and each positioning hole (14) is defined between a corresponding end and a corresponding protrusion (12) of the stationary base (10). The mounting feet (16) may be L-shaped, are respectively formed on and protrude from the ends of the stationary base (10) at a side opposite to the channels (11) and are connected securely to the body (42) of the object with fasteners. The elongated hole (15) is defined through the stationary base (10) along a longitudinal direction of the stationary base (10) and between the protrusions (12).

The slider (20) is connected securely to a slidable cover (41) of the object and is mounted slidably on the stationary base (10) along the channels (11). In an alternative embodiment, the sliding rail may have two or more sliders (20). The slider (10) has two opposite edges, four resilient arms (23), two wings (22) and a mounting hole (211). The edges of the slider (20) are respectively mounted slidably in the channels (11) in the stationary base (10). Each edge of the slider (20) has two resilient arms (23) mounted on and protruding obliquely from the edge. The arms (23) on a same edge protrude oppositely from each other. Each arm (23) has two ends (231,232) abutting respectively with the top and the bottom of a corresponding channel (11) in the stationary base (10). The wings (22) are respectively formed on and protrude from the edges of the slider (20), and the resilient arms (23) are formed respectively on the wings (22). Each wing (22) has a notch (221) defined in the wing (22) and engaging one of the protrusions (12) on the stationary base (10). With the engagement between the notches (221) in the wings (22) of the slider (20) and the protrusions (12) on the stationary base, the cover (41) can be held in a closed or an open position relative to the body (42). The mounting hole (211) is defined through the slider (20) to connect the slider (20) to the cover (42) with fasteners mounted through the mounting hole (211).

The plugs (30) are mounted respectively on the ends of the stationary base (10) to close the open ends of the channels (11) and to keep the slider (20) from detaching from the channels (11). Each plug (30) has an engaging block (31) formed on the plug (30) and engaging the positioning hole (14) near a corresponding end of the stationary base (10).

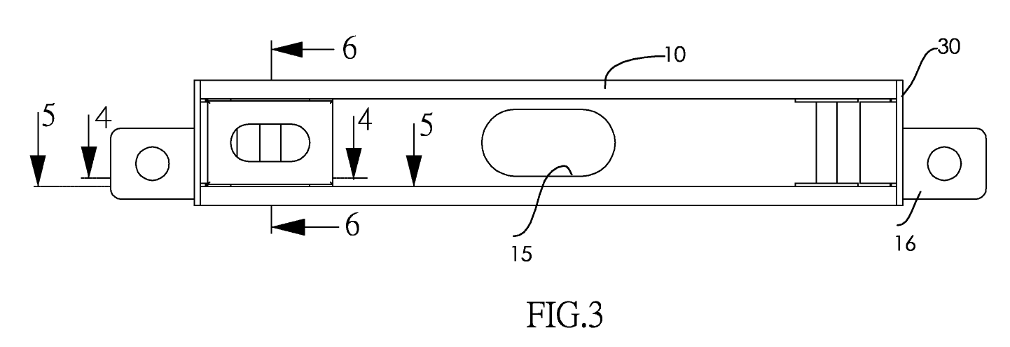

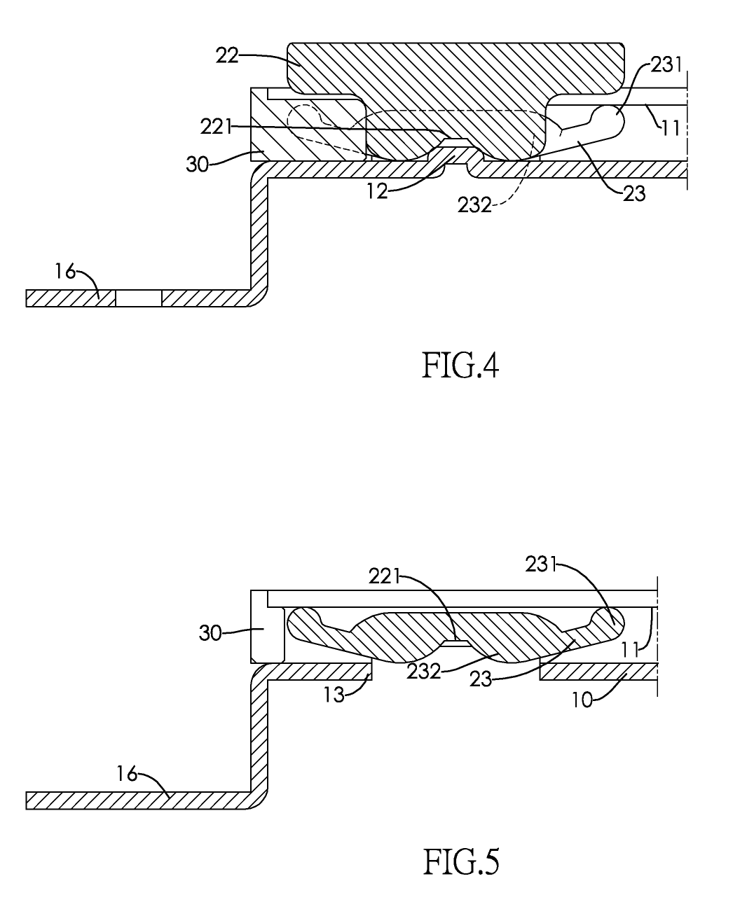

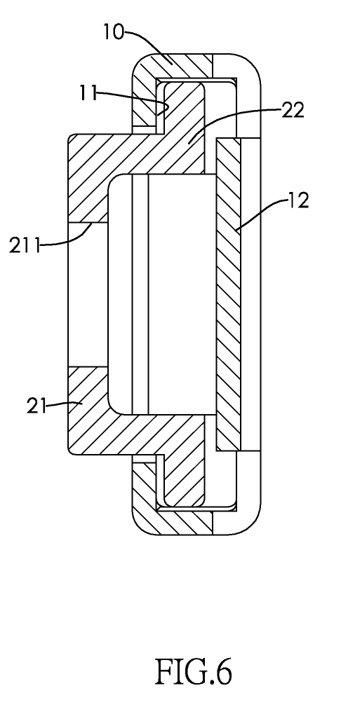

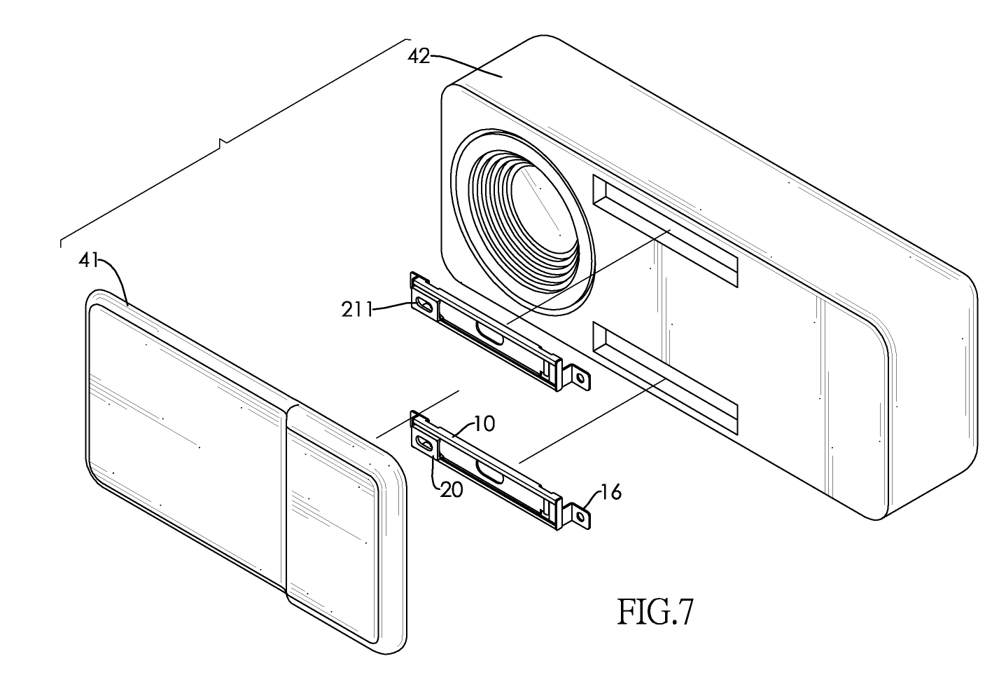

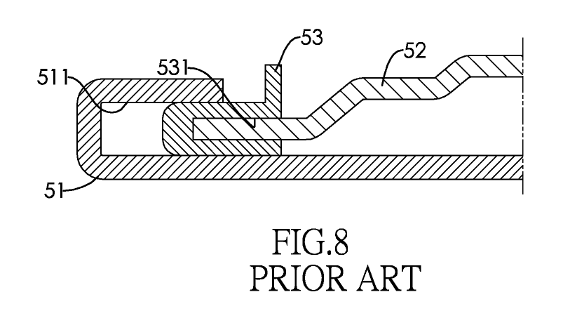

With reference to FIGS. 3 to 6, when the resilient arms (23) of the slider (20) are mounted in the channels (11), the ends (231,232) of the arms (23) abut respectively with the top and the bottom of the channels (11). With due to resiliency of the resilient arms (23), the resilient arms (23) can abut with the channels (11) tightly even if the channels (11) contain manufacturing imprecisions. This can make the movement of slider (20) along the channels (11) stable and prevent vibration during movement of the slider (20). In addition, the resilient arms (23) can be compressed to enter into the channels (11) having a small width, such that volume of the sliding rail can be reduced for minimization of electronic objects.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sliding rail comprising:
an elongated stationary base having two ends, two opposite edges and two channels defined respectively in the edges, and each channel having a top, a bottom and two open ends respectively at the ends of the stationary base;
a slider mounted slidably on the stationary base and having
two edges respectively mounted slidably in the channels in the stationary base, wherein each edge of the slider has two resilient arms mounted on and protruding obliquely from the edge and each arm having two ends abutting respectively with the top and the bottom of a corresponding channel in the stationary base; and
two plugs mounted respectively on the ends of the stationary base to close the open ends of the channels.

2. The sliding rail as claimed in claim 1, wherein
the stationary base further has two protrusions formed respectively near the ends of the stationary base;
the slider further has two wings respectively formed on and protruding from the edges of the slider and each wing having a notch defined in the wing and engaging one of the protrusions on the stationary base; and
the resilient arms are formed respectively on the wings.

3. The sliding rail as claimed in claim 2, wherein the stationary base further has four slots defined through the stationary base respectively at ends of the protrusions.

4. The sliding rail as claimed in claim 3, wherein the stationary base further has two positioning holes defined respectively near the ends of the stationary base and each between a corresponding end and a corresponding protrusion of the stationary base; and
each plug has an engaging block formed on the plug and engaging the positioning hole near a corresponding end of the stationary base.

5. The sliding rail as claimed in claim 4, wherein the stationary base further has two mounting feet respectively formed on and protruding from the ends of the stationary base.

6. The sliding rail as claimed in claim 5, wherein the stationary base further has an elongated hole defined through the stationary base along a longitudinal direction of the stationary base and between the protrusions.

7. The sliding rail as claimed in claim 6, wherein the slider further has a mounting hole defined through the slider.

8. The sliding rail as claimed in claim 1, wherein the stationary base further has two positioning holes defined respectively near the ends of the stationary base; and
each plug has an engaging block formed on the plug and engaging the positioning hole near a corresponding end of the stationary base.

9. The sliding rail as claimed in claim 1, wherein the stationary base further has two mounting feet respectively formed on and protruding from the ends of the stationary base.

10. The sliding rail as claimed in claim 1, wherein the stationary base further has an elongated hole defined through the stationary base along a longitudinal direction of the stationary base.

11. The sliding rail as claimed in claim 1, wherein the slider further has a mounting hole defined through the slider.

12. An object comprising:
a body;
a slidable cover connected slidably to the body with at least on sliding rail, wherein each one of the at least one sliding rail comprises
an elongated stationary base connected securely to the body, having two ends, two opposite edges and two channels defined respectively in the edges, and each channel having a top, a bottom and two open ends respectively at the ends of the stationary base;
a slider connected slidably to the cover, mounted slidably on the stationary base and having
two edges respectively mounted slidably in the channels in the stationary base, wherein each edge of the slider has two resilient arms mounted on and protruding obliquely from the edge and each arm having two ends abutting respectively with the top and the bottom of a corresponding channel in the stationary base; and
two plugs mounted respectively on the ends of the stationary base to close the open ends of the channels.

13. The object as claimed in claim 12, wherein
the stationary base of each one of the at least one sliding rail further has two protrusions formed respectively near the ends of the stationary base;
the slider of each one of the at least one sliding rail further has two wings respectively formed on and protruding from the edges of the slider and each wing having a notch defined in the wing and engaging one of the protrusions on the stationary base of the sliding rail; and
the resilient arms of each one of the at least one sliding rail are formed respectively on the wings of the slider of the sliding rail.

14. The object as claimed in claim 13, wherein the stationary base of each one of the at least one sliding rail further has four slots defined through the stationary base respectively at ends of the protrusions.

15. The object as claimed in claim 14, wherein the stationary base of each one of the at least one sliding rail further has two positioning holes defined respectively near the ends of the stationary base and each between a corresponding end and a corresponding protrusion of the stationary base; and
each plug of each one of the at least one sliding rail has an engaging block formed on the plug and engaging the positioning hole near a corresponding end of the stationary base of the sliding rail.

16. The object as claimed in claim 15, wherein the stationary base of each one of the at least one sliding rail further has two mounting feet respectively formed on and protruding from the ends of the stationary base.

17. The object as claimed in claim 16, wherein the stationary base of each one of the at least one sliding rail further has an elongated hole defined through the stationary base along a longitudinal direction of the stationary base and between the protrusions.

18. The object as claimed in claim 17, wherein the slider of each one of the at least one sliding rail further has a mounting hole defined through the slider.

19. The sliding rail as claimed in claim 12, wherein the stationary base of each one of the at least one sliding rail further has two positioning holes defined respectively near the ends of the stationary base; and
each plug of each one of the at least one sliding rail has an engaging block formed on the plug and engaging the positioning hole near a corresponding end of the stationary base of the sliding rail.

20. The object as claimed in claim 12, wherein the stationary base of each one of the at least one sliding rail further has
two mounting feet respectively formed on and protruding from the ends of the stationary base; and
an elongated hole defined through the stationary base along a longitudinal direction of the stationary base.
